(19) United States
(12) Patent Application Publication
(10) Pub. No.: US 2008/0036800 A1
(43) Pub. Date: Feb. 14, 2008

(54) MANIPULATION DESK FOR PRINTING MACHINES

(75) Inventors: Nobuyuki KISHIGI, Hiroshima-ken (JP); Kazunori IKEDA, Hiroshima-ken (JP); Takahide TOSHITO, Hiroshima-ken (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 11/669,433

(22) Filed: Jan. 31, 2007

(30) Foreign Application Priority Data
Aug. 9, 2006 (JP) 2006-217251

(51) Int. Cl. B41J 29/38

(52) U.S. Cl. 347/5

(57) ABSTRACT

A manipulation desk for controlling a supply of ink for each of a plurality of ink supply zones split in a width direction of printing paper in a printing machine. The manipulation desk includes a paper table for placing a sample printed paper thereon; a plurality of ink adjustment switches disposed so as to correspond to the ink supply zones along the width direction of the sample printed paper in front of a paper table; a plurality of indicators arranged on the paper table along the width direction of the sample printed paper; and a controller for selecting and lighting an indicator of the plurality of indicators that is used to position a specific position of the sample printed paper.

### BACKGROUND OF THE INVENTION

1) Field of the Invention

The present invention relates to a manipulation desk for controlling a supply of ink for each of a plurality of ink supply zones split in the width direction of printing paper in a printing machine, and more particularly to a manipulation desk for printing machines that can keep up with width changes of printing paper.

2) Description of the Related Art

In offset rotary web printing machines, the operator adjusts a supply of ink by hand to adjust the density and tone of images and characters that are printed. Such an ink supply adjustment is performed for each of the ink supply widths split in the axial direction of the printing cylinders (the plate cylinder and blanket cylinder), that is, in the printing width direction. The operator manipulates the ink supply adjustment switches provided so as to correspond to the ink supply widths, thereby adjusting a supply of ink.

Particularly, in rotary presses for newspapers, the newspaper sides of two-page-width are made using a four-page-wide web. That is, printing is performed on a four-page-wide web through printing cylinders, and the center of the four-page-wide web is subsequently split in to two two-page-wide spaces by a slitter. In discharging newspapers, two-page-wide spaces are overlaid in page order and fed to a folding machine, in which they are folded at the center of the two-page width and further at the up-and-down center of one page to produce a folded newspaper.

In the case of such a newspaper, generally, with a two-page-wide printed paper space (printed sample such as a color galley) placed on a paper table, an ink quantity is adjusted by checking the printed two-page-wide paper space. In front of the paper table of the manipulation desk, ink quantity adjustment switches (or ink adjustment keys) are provided so as to correspond to actual ink supply widths. Therefore, if a printed paper is appropriately placed on the paper table, the operator checks the printed paper to judge an ink quantity, and manipulates an ink adjustment key corresponding to each position on the printed paper to adjust an ink supply of a target portion, thereby being able to adjust the density and tone.

In rotary web printing machines, techniques have recently been developed so that they can handle various web widths (e.g., see Patent Document 1 (Japanese Patent Laid-Open Publication No. 2004-338814)). The Patent Document 1 discloses a rotary web printing machine in which webs from a plurality of web feed sections are printed in a plurality of printing sections and folded in a folding section. This rotary web printing machine is equipped with turn bars for turning the moving directions of the webs before they go into the folding section, and a plurality of triangular plates for guiding the webs to the folding section. By selecting turn bars or performing position adjustments, webs of various widths can be freely positioned with respect to the plurality of triangular plates.

However, in the technique that employs the above-described manipulation desk to adjust a supply of ink, when a web width used in the rotary machine is changed, it cannot be easily judged which position on the printing paper each ink adjustment switch on the manipulation desk indicates.

For that reason, in adjusting an ink quantity on the manipulation desk, the operator selects an ink adjustment switch based on the page position of a printed paper required to be adjusted and manipulates the selected switch. This can easily cause the occurrence of misjudgment and increase waste paper.

### SUMMARY OF THE INVENTION

The present invention has been made in view of the circumstances described above. Accordingly, it is the primary object of the present invention to provide a manipulation desk for printing machines that is capable of easily recognizing the position of a target ink adjustment switch so that the occurrence of waste paper can be prevented and a supply of ink can be properly adjusted, even when the width of a printing web is changed.

To achieve the aforementioned object, there is provided a manipulation desk for controlling a supply of ink for each of a plurality of ink supply zones split in a width direction of printing paper in a printing machine. The manipulation desk comprises four major components: (1) a paper table for placing a sample printed paper thereon; (2) a plurality of ink adjustment switches disposed near the paper table so as to correspond to the ink supply zones along a width direction of the sample printed paper placed on the paper table; (3) a plurality of indicators arranged on the paper table along the width direction of the sample printed paper placed on the paper table; and (4) control means for selecting and lighting an indicator of the plurality of indicators that is used to position a specific position of the sample printed paper so that a first width direction position of the sample printed paper relative to the plurality of ink adjustment switches on the paper table is the same position as a second width direction position relative to the plurality of ink supply zones of a print image that corresponds to the sample printed paper.

According to the manipulation desk of the present invention, when mounting a sample printed paper on the paper table, if the specific position of the sample printed paper is positioned based on the position in the printed paper width direction of the indicator selected and lit by the control means, the first width direction position of the sample printed paper relative to the plurality of ink adjustment switches on the paper table becomes the same position as the second width direction position relative to the plurality of ink supply zones of a print image that corresponds to the sample printed paper. Therefore, if a corresponding ink adjustment switch is manipulated by checking the sample printed paper placed on the paper table, the required ink supply of the ink supply zone relative to a print image that corresponds to the sample printed paper is adjusted. Thus, the position of an ink adjustment switch to be manipulated can be easily recognized, whereby the occurrence of waste paper can be suppressed and a supply of ink can be properly adjusted.

In the manipulation desk of the present invention, the aforementioned printing machine may be a rotary web printing machine; the aforementioned printing paper may be a printing web with a four-page width; the aforementioned sample printed paper may be one of two two-page-wide spaces into which the printing web is split in a width direction thereof; and the aforementioned control means may calculate the second width direction position, based on a third width direction position relative to the printing machine of a printing area equivalent to the two-page-wide space.

This makes it possible to easily and precisely select an indicator which should be lit.

In this case, the aforementioned control means preferably grasps the third width direction position, based on a position of a printing plate of the printing area relative to a necessary printing cylinder of the printing machine and on a width of the printing web obtained from a web holding unit which holds the printing web.

This renders it possible to easily and reliably grasp the width direction position relative to the printing machine of a print region equivalent to the two-page-wide space.

In a web holding stand, even when the width of a web is increased or reduced, the web width can be precisely calculated. This makes it possible to grasp the width direction position relative to the printing machine of a space or its printing area, on the basis of a calculated web width and the position of the printing plate relative to the printing cylinder.

In the manipulation desk of the present invention, the specific position of the sample printed paper is preferably the center position in the width direction of the two-page-wide space, or either or both of end positions in the width direction of the two-page-wide space.

Therefore, when the width of a web is greatly changed, there are cases where it is misjudged which end is aligned with the indicator.

In the manipulation desk of the present invention, the aforementioned indicators preferably comprise light-emitting diode lamps, and preferably the aforementioned plurality of ink adjustment switches are transversely arranged in front of the paper table.

Thus, if the aforementioned indicators are light-emitting diode lamps, small indicators can be adopted and therefore fine positioning becomes possible. In addition, if the aforementioned plurality of ink adjustment switches are transversely arranged in front of the paper table, controllability relating to ink supply adjustments is enhanced.

A printing machine according to the present invention is equipped with the above-described manipulation desk.

A print according to the present invention is obtained by the above-described printing machine.

In accordance with the present invention, there is provided a method which is used in a manipulation desk comprising a paper table for placing a sample printed paper thereon, a plurality of ink adjustment switches disposed along a width direction of the paper table so as to correspond to ink supply zones, a plurality of indicators arranged in parallel with the plurality of ink adjustment switches along a width direction of the paper table, and control means for selecting and lighting a specific indicator of the plurality of indicators, and which lights the specific indicator to guide positioning of the sample printed paper. The method of the present invention comprises a step of inputting information of a width direction mounting position of a printing plate for each printed paper that is mounted on a plate cylinder of a printing machine, to the control means; and a step of selecting and lighting a specific indicator of the plurality of indicators based on the input width direction mounting position information by the control means so that a width direction position of the sample printed paper relative to the plurality of ink adjustment switches on the paper table is the same position as a width direction position relative to the plurality of ink supply zones of a print image that corresponds to the sample printed paper, and thereby guiding positioning of the sample printed paper.

According to the aforementioned method of the present invention, when mounting a sample printed paper on the paper table, if the specific position of the sample printed paper is positioned based on the position in the printed paper width direction of the indicator selected and lit by the control means, the first width direction position of the sample printed paper relative to the plurality of ink adjustment switches on the paper table becomes the same position as the second width direction position relative to the plurality of ink supply zones of a print image that corresponds to the sample printed paper. Therefore, if a corresponding ink adjustment switch is manipulated by checking the sample printed paper placed on the paper table, the required ink supply of the ink supply zone relative to a print image that corresponds to the sample printed paper is adjusted. Thus, the position of an ink adjustment switch to be manipulated can be easily recognized, whereby the occurrence of waste paper can be suppressed and a supply of ink can be properly adjusted.

In the method of the present invention, the width direction mounting position information is preferably used detection information obtained from a position sensor that is attached to the plate cylinder for detecting the width direction mounting position.

A printing method according to the present invention is a method of carrying out printing by adjusting a plurality of ink adjustment switches, using the above-described method of guiding the positioning of the sample printed paper.

In the manipulation desk of the present invention, when mounting a sample printed paper on the paper table, if the specific position of the sample printed paper is positioned based on the position in the printed paper width direction of the indicator selected and lit by the control means, the first width direction position of the sample printed paper relative to the plurality of ink adjustment switches on the paper table becomes the same position as the second width direction position relative to the plurality of ink supply zones of a print image that corresponds to the sample printed paper. Therefore, if a corresponding ink adjustment switch is manipulated by checking the sample printed paper placed on the paper table, the required ink supply of the ink supply zone relative to a print image that corresponds to the sample printed paper is adjusted. Thus, the position of an ink adjustment switch to be manipulated can be easily recognized, whereby the occurrence of waste paper can be suppressed and a supply of ink can be properly adjusted.

If (1) the aforementioned printing machine is a rotary web printing machine, (2) the aforementioned printing paper is a printing web with a four-page width, (3) the aforementioned sample printed paper is one of two two-page-wide spaces into which the printing web is split in a width direction thereof, and (4) the aforementioned control means calculates the second width direction position, based on a third width direction position relative to the printing machine of a printing area equivalent to the two-page-wide spaces, then it becomes possible to easily and precisely select an indicator that is to be lit.

In this case, if the aforementioned control means grasps the third width direction position, based on a position of a printing plate of the printing area relative to a necessary printing cylinder of the printing machine and on a width of the printing web obtained from a web holding unit which holds the printing web, then it becomes possible to easily and reliably grasp the width direction position relative to the printing machine of a print region equivalent to the two-page-wide space.

In addition, if the specific position of the sample printed paper is the center position in the width direction of the two-page-wide space, the sample printed paper can be properly placed on the paper table. If the specific position of the sample printed paper is either of the end positions in the width direction of the two-page-wide space, when the width of a web is greatly changed, there are cases where it is misjudged which end is aligned with the indicator.

Moreover, if the aforementioned indicators are light-emitting diode lamps, small indicators can be adopted and therefore fine positioning becomes possible. In addition, if the aforementioned ink adjustment switches are transversely arranged in front of the paper table, controllability relating to ink supply adjustments is enhanced.

### BRIEF DESCRIPTION OF THE DRAWINGS

The present invention will be described in further detail with reference to the accompanying drawings wherein:

FIG. 1 is a perspective view showing a manipulation desk for a printing machine constructed in accordance with a preferred embodiment of the present invention;

FIG. 2A is a front view showing the paper table of the manipulation desk shown in FIG. 1;

FIG. 2B is an enlarged view of the paper table shown in FIG. 2A;

FIG. 3 is a front view showing an example of the lighting of a lamp and arrangement of a sample printed paper on the paper table of the manipulation desk of the preferred embodiment;

FIG. 4 is a front view showing another example of the lighting of a lamp and arrangement of a sample printed paper on the paper table of the manipulation desk of the preferred embodiment;

FIG. 5 is a plan view showing one of the rotary web printing machines arranged transversely as the printing machine according to the preferred embodiment of the present invention;

FIG. 6 is a front view of the rotary web printing machine shown in FIG. 5;

FIG. 7 is a plan view showing the relationship between a printing plate, a slitter, a turn bar, a paper press roller, and a triangular plate of the rotary web printing machine shown in FIG. 5; and

FIG. 8 is a schematically perspective view of the rotary web printing machine according to the preferred embodiment of the present invention.

### DESCRIPTION OF THE PREFERRED EMBODIMENTS

A preferred embodiment of the present invention will hereinafter be described with reference to the drawing.

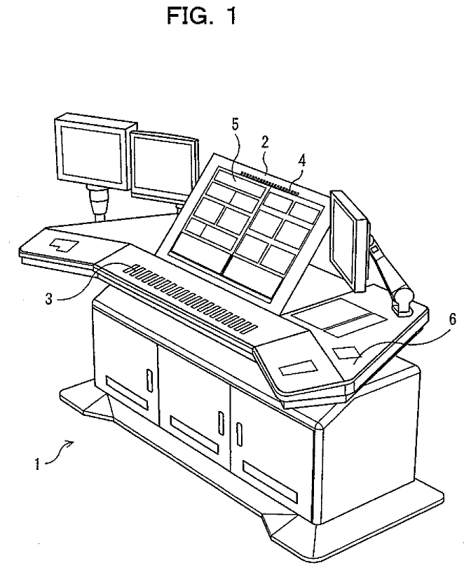

FIGS. 1 to 8 show a printing machine manipulation desk and a printing machine according to a preferred embodiment of the present invention, and based on these figures, the preferred embodiment will be described.

(Printing Machine)

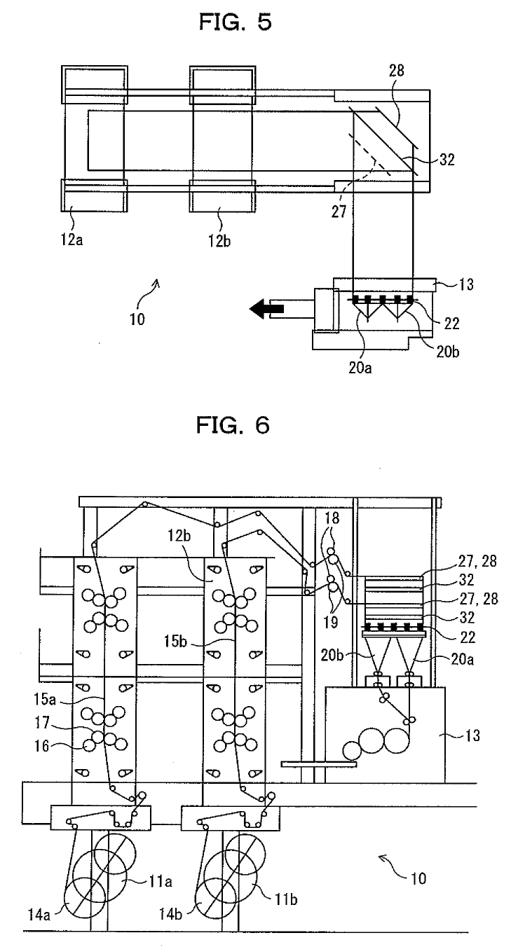

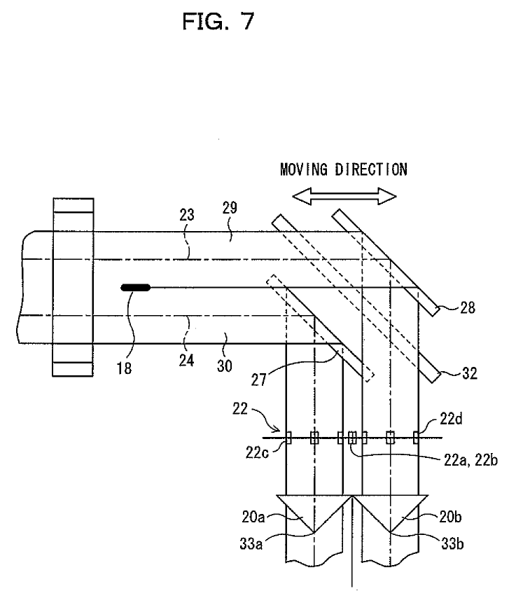

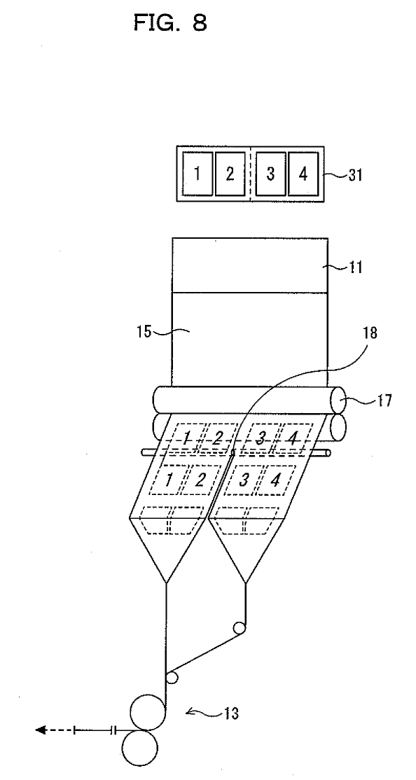

Referring initially to FIGS. 5 to 8, there is shown a rotary web printing machine that is a printing machine according to the preferred embodiment of the present invention. FIGS. 5 to 7 show the rotary web printing machine described in the aforementioned Patent Document 1. FIG. 5 is a plan view showing one of the rotary web printing machines arranged transversely, FIG. 6 is a front view of the rotary web printing machine shown in FIG. 5, and FIG. 7 is a plan view showing the relationship between a printing plate, a slitter, a turn bar, a paper press roller, and a triangular plate in the case of printing a web width (non-standard web width) which differs from a stand web width. FIG. 8 is a schematically perspective view of the rotary web printing machine showing the relationship of printing space to a printing web.

As shown in FIGS. 5 and 6, in the rotary web printing machine, a first web feed section 11a and a first printing section 12a are arranged in parallel with a second web feed section 11b and a second printing section 12b, and a first web 15a and a second web 15b travel straight until they reach a folding section 13. The folding section 13 is arranged at a right angle to the row of the web feed sections 11a, 11b and row of printing sections 12a, 12b, and a folded print is discharged in the direction indicated by an arrow in FIG. 5.

In order for the webs 15a, 15b printed by printing plate cylinders 16 and blanket cylinders 17 in the first and second printing sections 12a, 12b to move from the printing sections 12a, 12b to the folding section 13, it is necessary to turn their moving directions 90 degrees. For this reason, as shown in FIG. 5, two turn bars 27, 28 are provided for one web. The positions of the turn bars 27, 28 can be changed in the directions shown in FIG. 7 by adjusters (not shown) to cause two split webs 29, 30 to travel so that the center creases 23, 24 of the two split webs 29, 30 coincide with the extreme ends 33b, 33a of the triangular plates 20b, 20a. For a web which is employed for standard newspaper printing, a dedicated turn bar 32 is installed in a path different from the paths of the turn bars 27, 28.

A description will be given in the case of printing on a non-standard web with a narrow width. As shown in FIGS. 6 and 7, even when a web width is changed, as with the case of a standard web width, the web is caused to travel so that the center of the web width coincides with the center line of the printing machine. Each of the printed webs 15a, 15b is split into webs 29, 30 in the traveling direction on a drag roller 19 by a slitter 18. As shown in FIG. 7, the traveling direction of the web 29 is turned 90 degrees by the turn bar 28 so that the crease 23 of the web 29 coincides with the extreme end 33b of the triangular plate 20b. Similarly, the traveling direction of the web 30 is turned 90 degrees by the turn bar 28 so that the crease 24 of the web 30 coincides with the extreme end 33a of the triangular plate 20a. Thus, with the triangular plates 20a, 20b fixed, necessary folding can be performed.

Note that in the case of newspaper printing, the two webs 29, 30 are both turned in direction by the turn bar 32 that is at a standard position. This turn bar 32, as shown in FIG. 7, has a length corresponding to the full web width of a standard web, and the turn bars 27, 28 for narrow web widths other than that are disposed in paths differing from that of the turn bar 32. The positions of the triangular plates 20a, 20b are at the positions where the creases 23, 24 of the webs 29, 30 coincide with the extreme ends 33b, 33a of the triangular plates 20b, 20a, so they do not need to be moved because of a change in web width.

Therefore, when switching a web width from newspaper printing (standard web width printing) to non-standard web width printing, components requiring a change in position are the turn bars 27, 28. The positions of the turn bars 27, 28 can be adjusted by moving four rollers 22a, 22b, 22c, 22d of the paper press rollers 22 provided on the drag rollers on the triangular plates. When switching a web width from non-standard web width printing to standard web width printing, the web needs to be moved along a path in which the turn bar 32 is arranged. This adjustment can be performed by moving only the aforementioned four rollers 22a, 22b, 22c, 22d in the opposite direction.

In both cases of the standard web width printing and non-standard web width printing using such a rotary web printing machine, as shown in FIG. 8, images on a printing plate 31 mounted on the plate cylinder are printed on the web 15 fed from the web feed section 11. At this time, the printing is generally performed at a four-page width, and the width direction center of the four-page-wide web 15 is subsequently split into two two-page-wide webs by the splitter 18. In the folding machine 13, each two-page-wide web is folded at its center and cut in the vertical direction (traveling direction), and in the subsequent process (not shown), each one-page-wide web is folded at its vertical center in two. In this manner, folded newspapers are discharged from the folding machine 13.

Such a rotary web printing machine is equipped with ink supply units for supplying ink to the printing cylinders (the plate cylinder and blanket cylinder) of the printing sections 12a, 12b. Each ink supply unit has an array of ink keys arranged in the web width direction (axial direction of the printing cylinder), and by adjusting the opening degree of each ink key, a supply of ink can be adjusted for each ink key width (each ink supply zone).

To adjust a supply of ink for each ink supply zone, a manipulation desk 1 such as that shown in FIG. 1 is installed in an printing operator room or the like.

(Manipulation Desk)

As shown in FIG. 1, the manipulation desk 1 is provided with a paper table 2 for placing a sample printed paper 5 thereon, and a plurality of ink adjustment switches (ink adjustment keys) 3 arranged in front of the paper table 2 along the width direction of the sample printed paper 5 placed on the paper table 2. The plurality of ink adjustment switches 3 are arranged to correspond to the actual intervals of the ink supply zones. Note that the above-described configuration of the manipulation desk 1 is well known in the prior art.

In the preferred embodiment, on the space of the paper table 2 of the manipulation desk 1, a plurality of light-emitting diode (LED) lamps 4 as indicators are arranged along the width direction of the sample printed paper 5 placed on the paper table 2. These LED lamps 4 are used for the positioning of the sample printed paper 5 that is placed on the paper table 2, and are arranged transversely on the upper portion of the paper table 2 so that they are not hidden with the sample printed paper 5 placed on the paper table 2 and are not away from the sample printed paper 5 placed on the paper table 2.

The lighting of the LED lamps 4 is controlled through a controller 6 installed on the manipulation desk 1. In response to input information of the mounting position of a printing plate for each page which is mounted on the plate cylinder of the printing machine, the controller 6 functions to select and light any one of the LED lamps 4. For the information of the mounting position of the printing plate for each page, a position sensor for detecting a mounting position of a printing plate may be attached to a plate cylinder for inputting the detection information from the sensor to the controller 6, or the mounting position of a printing plate for each page may be input to the controller 6 by hand.

Particularly, the printing machine of the preferred embodiment is the above-described rotary web printing machine, and as described above, printing paper is the four-page-wide web 15, and the sample printed paper 5 to be placed on the paper table 2 is equivalent to one of two two-page-wide spaces into which the four-page-wide web 5 is split in the width direction. Therefore, the mounting position of the printing plate for each page in the preferred embodiment means the mounting position of the printing plate relative to the two-page-wide space.

The width direction position of the printed paper relative to the plate cylinder is the width direction position of the printed paper relative to each ink supply zone (or each ink key). The determination of the central position in the width direction of the two-page-wide space relative to the plate cylinder makes it possible to precisely recognize the entire width direction position of the two-page-wide space. In a stand which holds webs (e.g., a mill roll stand in the web feed section), even when the width of a web is increased or reduced, the web width can be precisely calculated. This makes it possible to grasp the width direction position relative to the printing machine of a space or its printing area, on the basis of a calculated web width and the position of the printing plate relative to the printing cylinder.

The ink adjustment switches 3 of the manipulation desk 1 are at the positions corresponding to the ink supply zones, so any one of the lamps 4 can be selected and lit so that the width direction position relative to the ink adjustment switches 3 of a two-page-wide space (which is a sample printed paper placed on the paper table 2) is the same as the width direction position relative to the plate cylinder of the printing plate corresponding to this sample printed paper (i.e., the width direction position relative to the ink supply zones of a print image corresponding to the sample printed paper).

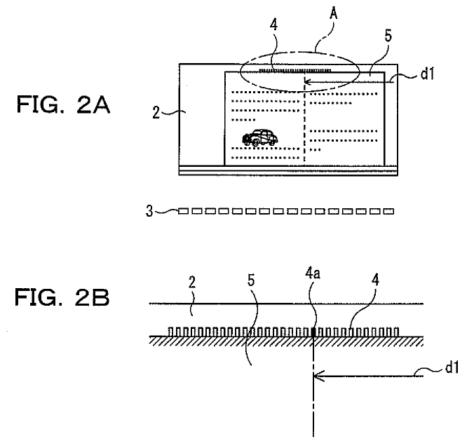

For instance, if the width direction center of a two-page-wide space is away from the reference position of one end of a plate cylinder by d1, as shown in FIGS. 2A and 2B, the controller 6 is able to light the LED lamp 4a of the paper table 2 that is away from a position corresponding to that reference position by d1.

(Operation and Advantages)

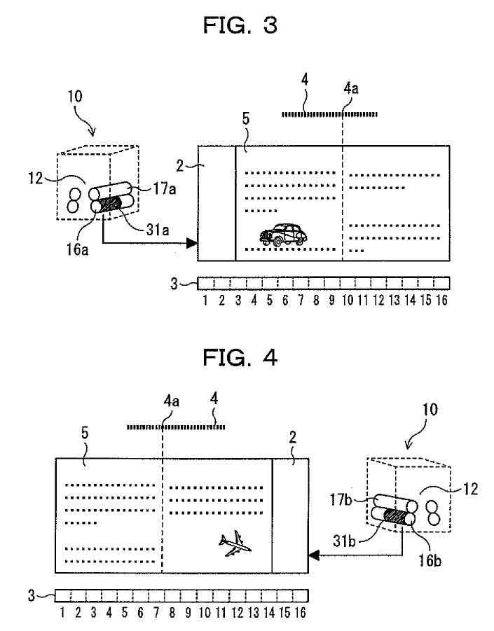

The manipulation desk 1 of the printing machine according to the preferred embodiment of the present invention is constructed as described above. Therefore, for example, as shown in FIG. 3, when mounting a printing plate 31a on a corresponding reverse-printing plate cylinder 16a of a certain printing section 12 of the printing machine 10 to print on the web through a blanket cylinder 17a, the mounting position of the printing plate 31a relative to the plate cylinder 16a is input to the controller 6, and in response to the mounting position of the printing plate 31a, the controller 6 selects a corresponding LED lamp 4a from a plurality of the LED lamps 4 arranged on the paper table 2 and lights the selected lamp 4a.

As shown in FIG. 4, when mounting a printing plate 31b on a corresponding printing plate cylinder 16b of a certain printing section 12 of the printing machine 10 to print on the web through a blanket 17b, the mounting position of the printing plate 31b of the plate cylinder 16b is input to the controller 6, and in response to the mounting position of the printing plate 31b, the controller 6 selects a corresponding LED lamp 4a from a plurality of LED lamps 4 arranged on the paper table 2 and lights the selected lamp 4a.

Therefore, after arranging a two-page-wide sample printed paper at the position of the lit LED lamp 4a, the printing operator manipulates an ink adjustment switch 3 of the ink adjustment switches 3 in front of the paper table 2 that corresponds to the width direction position of that sample printed paper 5, there by being able to adjust an ink quantity that is supplied to a corresponding place of the printing paper.

Thus, even when a change in a web width shifts the web position (image position to be printed) relative to the printing machine in the web width direction, the printing operator easily and quickly selects and manipulates the necessary ink adjustment switch 3. As a result, the problem of the adjustment of an ink supply to an incorrect place is avoided, and the occurrence of waste paper is also suppressed.

Particularly, in the case where the adjustment of an ink supply is required in a short time in newspaper printing or the like, the present invention is extremely effective.

In addition, as in newspaper printing, etc., when splitting a four-page-wide web into two two-page-wide webs in the web width direction and performing an ink supply adjustment on the two-page-wide web, if a web width is changed, the web position (image position to be printed) relative to the printing machine will be shifted in the web width direction and therefore the position of the sample printed paper 5 on the paper table 2 will be easily misjudged. However, the present invention can reliably prevent such a misjudgment.

### OTHER EMBODIMENTS

While the present invention has been described with reference to the preferred embodiment thereof, the invention is not to be limited to the details given herein, but may be modified within the scope of the invention hereinafter claimed.

For example, a specific position or specific positions of a sample printed paper may be either or both of end positions in the width direction of a two-page-wide space.

In the above embodiment, the position indicators comprise LED lamps, so small indicators can be adopted, where by very fine positioning becomes possible. However, the position indicators are not to be limited to LED lamps, but may include existing indicators of every kind. If ink adjustment switches are sheet-type switches disposed on a board, switches of a narrower width can be manufactured and therefore an ink supply adjustment that is finer with respect to the width direction of a paper becomes possible. However, the ink adjustment switches are not to be limited to such sheet-type switches, but may include existing manipulation switches and press buttons of all kinds.

What is claimed is:

1. A manipulation desk for controlling a supply of ink for each of a plurality of ink supply zones split in a width direction of printing paper in a printing machine, comprising:
a paper table for placing a sample printed paper thereon;
a plurality of ink adjustment switches disposed near said paper table so as to correspond to said ink supply zones along a width direction of said sample printed paper placed on said paper table;
a plurality of indicators arranged on said paper table along the width direction of said sample printed paper placed on said paper table; and
control means for selecting and lighting an indicator of said plurality of indicators that is used to position a specific position of said sample printed paper so that a first width direction position of said sample printed paper relative to the plurality of ink adjustment switches on said paper table is the same position as a second width direction position relative to said plurality of ink supply zones of a print image that corresponds to said sample printed paper.

2. The manipulation desk as set forth in claim 1, wherein
said printing machine is a rotary web printing machine;
said printing paper is a printing web with a four-page width;
said sample printed paper is one of two two-page-wide spaces into which said printing web is split in a width direction thereof; and
said control means calculates said second width direction position relative to the plurality of ink supply zones of a print image equivalent to said sample printed paper, based on a third width direction position relative to said printing machine of a printing area equivalent to said two-page-wide spaces.

3. The manipulation desk as set forth in claim 2, wherein said control means grasps said third width direction position relative to said printing machine of its printing area equivalent to said two-page-wide paper, based on a position of a printing plate of said printing area relative to a necessary printing cylinder of said printing machine and on a width of said printing web obtained from a web holding unit which holds said printing web.

4. The manipulation desk as set forth in claim 2, wherein the specific position of said sample printed paper is a center position in a width direction of said two-page-wide space, or either or both of end positions in the width direction of said two-page-wide space.

5. The manipulation desk as set forth in claim 3, wherein the specific position of said sample printed paper is a center position in a width direction of said two-page-wide space, or either or both of end positions in the width direction of said two-page-wide space.

6. The manipulation desk as set forth in claim 1, wherein
said plurality of indicators comprise light-emitting diode lamps; and
said plurality of ink adjustment switches are transversely arranged in front of said paper table.

7. The manipulation desk as set forth in claim 5, wherein
said plurality of indicators comprise light-emitting diode lamps; and
said plurality of ink adjustment switches are transversely arranged in front of said paper table.

8. A printing machine equipped with the manipulation desk as set forth in claim 1.

9. A print obtained by the printing machine as set forth in claim 6.

10. A method for guiding positioning of a sample printed paper which is used in a manipulation desk comprising a paper table for placing a sample printed paper thereon, a plurality of ink adjustment switches disposed along a width direction of said paper table so as to correspond to ink supply zones, a plurality of indicators arranged in parallel with said plurality of ink adjustment switches along a width direction of said paper table, and control means for selecting and lighting a specific indicator of said plurality of indicators, and which lights said specific indicator to guide positioning of said sample printed paper, said method comprising:
a step of inputting information of a width direction mounting position of a printing plate for each paper that is mounted on a plate cylinder of a printing machine, to said control means; and
a step of selecting and lighting a specific indicator of said plurality of indicators based on said input width direction mounting position information by said control means so that a width direction position of said sample printed paper relative to the plurality of ink adjustment switches on said paper table is the same position as a width direction position relative to said plurality of ink supply zones of a print image that corresponds to said sample printed paper, and thereby guiding positioning of said sample printed paper.

11. The method as set forth in claim 10, wherein said width direction mounting position information is detection information obtained from a position sensor that is attached to said plate cylinder for detecting said width direction mounting position.

12. A method of carrying out printing by adjusting said plurality of ink adjustment switches, using the method as set forth in claim 10.
